(19) United States
(12) Patent Application Publication
(10) Pub. No.: US 2014/0037823 A1
(43) Pub. Date: Feb. 6, 2014

(54) Beverage concentrate to facilitate hydration, absorption of nutritional components, efficient in vivo energy transfer, and concentrate homogeneity

(71) Applicants: Gary S. Kehoe, Phoenix, AZ (US); Stephen B. Roman, Phoenix, AZ (US); Cecile Kehoe, Phoenix, AZ (US); Jonathon S. Cooper, Phoenix, AZ (US)

(72) Inventors: Gary S. Kehoe, Phoenix, AZ (US); Stephen B. Roman, Phoenix, AZ (US); Cecile Kehoe, Phoenix, AZ (US); Jonathon S. Cooper, Phoenix, AZ (US)

(21) Appl. No.: 13/507,818

(22) Filed: Jul. 31, 2012

(51) Int. Cl. A23L 1/29; A23L 2/52

(52) U.S. Cl. CPC A23L 1/296; A23L 2/52
USPC 426/590

(57) ABSTRACT

A system hydrates an individual prior to participation in a sporting event. The system comprises a container charged with a thirst inducing aqueous nutritional supplement gel composition and configured to dispense repeatedly a dose of said aqueous gel composition having a selected volume. The selected volume of the dose is in the range of 0.25 to 3.0 cc. The thirst inducing gel composition has a viscosity in the range of 3000 to 12,500; has a pH in the range of 2.0 to 2.8. The gel composition also includes 9% to 30% by weight of a flavoring; at least one acidulant selected from a group consisting of citric acid, ascorbic acid, malic acid, and tartaric acid; at least one sweetener; 0.03 to 0.09% by weight of piperines; and, 35% to 40% by weight water.

This invention relates to a beverage concentrate and to methodologies for hydrating an individual prior to, during, and after physical exertion or after loss of bodily fluids by perspiration during ambient weather conditions or other conditions.

Evidence suggests that even a minor level of under-hydration in the range of about two percent of body weight can cause a significant measurable decrease in endurance and performance. And, it takes as much as twenty-four hours to return a dehydrated individual to a properly hydrated state.

It is preferred that about one to one-and-a-half hours prior to exercising, an individual ingest a relatively large volume of fluid on the order of up to about one-half liter. After such ingestion, fluids should be sipped at a rate of about one-half cup every ten minutes up until the exercise or sporting event begins.

Individuals often use the sensation of thirst as an indicator of fluid need. This practice is not encouraged because thirst typically is an sensation the body produces when it has already lost one and a half to two liters of water.

We have discovered a novel system which functions to increase the likelihood that an individual will properly hydrate before, during, and after exercise.

The system comprises a container charged with a thirst inducing aqueous nutritional supplement gel composition and configured to dispense repeatedly a dose of said aqueous gel composition having a selected volume in the range of 0.25 to 3.0 cc. The thirst inducing gel composition has a viscosity in the range of 3000 to 12,500; has a pH in the range of 2.0 to 2.8; and includes 9% to 30% by weight of a flavoring, includes at least one acidulant selected from a group consisting of citric acid, ascorbic acid, malic acid, and tartaric acid, includes at least one sweetener, includes 0.03 to 0.09% by weight of piperines, and includes 35% to 40% by weight water. The composition capitalizes on the sensation of thirst to increase the likelihood an individual will adequately hydrate. In particular, the composition generates a thirst sensation which encourages an individual to increase his or her consumption of a beverage.

In another embodiment of the invention, the system comprises a container charged with a thirst inducing aqueous nutritional supplement gel composition and configured to dispense repeatedly a dose of said aqueous gel composition having a selected volume in the range of 0.25 to 3.0 cc. The thirst inducing gel composition has a viscosity in the range of 3000 to 12,500 centipoise; has a pH in the range of 2.0 to 2.8; and includes 9% to 30% by weight of a flavoring, includes at least one acidulant selected from a group consisting of citric acid, ascorbic acid, malic acid, and tartaric acid, includes at least one sweetener, includes 0.03 to 0.09% by weight of piperines, includes 8.0% to 15% by weight monopotassium phosphate, and includes 35% to 40% by weight water. The composition capitalizes on the sensation of thirst to increase the likelihood an individual will adequately hydrate. In particular, the composition generates a thirst sensation which encourages an individual to increase his or her consumption of a beverage.

In a further embodiment of the invention, the system comprises a container charged with a thirst inducing aqueous nutritional supplement gel composition and configured to dispense repeatedly a dose of said aqueous gel composition having a selected volume in the range of 0.25 to 3.0 cc. The thirst inducing gel composition has a viscosity in the range of 3000 to 12,500 centipoise; has a pH in the range of 2.0 to 2.8; and includes 9% to 30% by weight of a flavoring, includes at least one acidulant selected from a group consisting of citric acid, ascorbic acid, malic acid, and tartaric acid, includes at least one sweetener, includes 0.03 to 0.09% by weight of piperines, includes 8.0% to 15% by weight monopotassium phosphate, includes 2% to 6% by weight ATP, includes 0.05% to 1.2% by weight cordyceps-sinensis, includes 1.5% to 4.0% by weight CoQ10, and includes 35% to 40% by weight water. The composition capitalizes on the sensation of thirst to increase the likelihood an individual will adequately hydrate. In particular, the composition generates a thirst sensation which encourages an individual to increase his or her consumption of a beverage.

When a gel form of the aqueous concentrate of the invention is utilized, the viscosity of the concentrate is in the range of 2,500 to 12,500 centipoise. When a less viscous liquid form of the invention is utilized, the viscosity of the concentrate is in the range of 50 to 250 centipoise.

The aqueous concentrate preferably is used to charge a container which can dispense measured doses of the concentrate to be admixed in a selected quantity of water. Such a dose is presently preferably in the range of 0.25 cc to 3.0 cc. Containers which dispense measured doses are known in the art and are not detailed herein. The quantity of water receiving each dose is in the range of four fluid ounces to twenty-four fluid ounces, preferably six to sixteen fluid ounces.

Natural, organic, non-organic, or artificial flavorings can be utilized in the concentrate of the invention, although natural flavorings are preferred. Many such flavorings are available and well known to those in the art. Some examples of flavorings can be seen in the examples below. The weight percent of flavorings in the concentrates of the invention are in the range of 5% to 40% by weight, more preferably 9% to 30% by weight. If the flavoring utilized is a highly concentrated flavoring then the weight percent of such a highly concentrated flavoring may, if desired, be in the range of 5% to 15% by weight, preferably 5% to 13% by weight.

When monopotassium phosphate is utilized as an electrolyte source in the concentrate of the invention, the weight percent is in the range of 5% to 65% by weight, more preferably 8% to 15% by weight. Other electrolytes can be utilized in the concentrate of the invention, either in place of or in combination with monopotassium phosphate, but monopotassium phosphate is preferred.

While any natural, organic, or artificial sweetener can be utilized in the concentrate of the invention, in the event a high intensity artificial sweetener is utilized, acesulfame potassium and sucralose are preferred, preferably in the range of 05.% to 3.5% by weight.

One of the principal functions of the invention is to induce thirst, or the sensation of thirst. To this end, some preferred thirst inducing components are citric acid, ascorbic acid, malic acid, tartaric acid, electrolytes, piperines, flavors, and sweeteners. In particular, the combination of piperines and relatively high concentrations of flavoring have been found to produce a synergistic effect which facilitates hydration in individuals. Piperines utilized in the invention are produced from peppers and, in addition, to facilitating the induction of thirst, also function to increase the bioavailability, i.e. the availability and absorption of various nutrients including herbal extracts, water-soluble vitamins, fat soluble vitamins, antioxidant, amino acids, and minerals. The preferred concentration of piperines in the aqueous concentrates of the invention is in the range of 0.001% to 0.75% by weight, preferably in the range of 0.03% to 0.09% by weight.

ATP can be utilized in the aqueous concentrate to provide energy in a form that is readily available for use by cells. The concentration of ATP in the aqueous concentrate is in the range of 0.5% to 15%, preferably 2% to 6% by weight.

Cordyceps-sinensis can be utilized in the aqueous concentrate to provide adenosine. Adenosine is a nucleotide that is integral in the production of ATP. The concentration of cordyceps-sinensis is in the range of 0.01% to 5%, preferably 0.05% to 1.2% by weight.

CoQ10 can be utilized in the aqueous concentrate of the invention to facilitate the transfer of chemical energy inside cells. The concentration of CoQ10 is in the range of 0.5% to 20%, preferably 1.5% to 4% by weight.

### EXAMPLE 1

The ingredients set forth below in Table 1 for an energy gel formulation are provided.

TABLE 1

| | | Weight |
|---|---|---|
| | | (gm) in |
| Ingredient | Weight % | 100 grams |
| Purified Water | 39.9550 | 39.9550 |
| Sucralose | 2.1030 | 2.1030 |
| (Sweetener) | | |
| Acesulfame | 1.0450 | 1.0450 |
| Potassium | | |
| (Sweetener) | | |
| Vitamin C | 3.5500 | 3.5500 |
| Citric Acid | 7.3100 | 7.3100 |
| 1,3-propanediol | 2.0000 | 2.0000 |
| Piperines | 0.4280 | 0.4280 |
| Xanthan Gum | 0.6500 | 0.6500 |
| Taurine | 3.4500 | 3.4500 |
| Potassium sorbate | 0.0500 | 0.0500 |
| Natural Flavoring | 29.7540 | 29.7540 |
| Vitamin B12 | 0.0104 | 0.0104 |
| (1.2 mcg/1.6 g shot, | | |
| 20% RDA) | | |
| Vitamin B3 | 0.3450 | 0.3450 |
| (4 mg shot, 20% RDA) | | |
| L-theanine | 0.4600 | 0.4600 |
| Inositol | 0.4600 | 0.4600 |
| Caffeine powder | 4.2810 | 4.2810 |
| Caffeine powder | 2.0880 | 2.0880 |
| Vitamin B5 | 0.0345 | 0.0345 |
| TOTALS | 100.00 | 100.00 |
| Totals without water | 59.69 | 51.02 |

### Mixing Instructions:

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. In a separate container, suspend xanthan gum in propanediol to produce a xanthan gum suspension.
7. Add xanthan gum suspension to homogeneous composition and mix until uniform to produce the final composition.

The final gel composition has a pH of 2.4 and a viscosity of 3940 centipoise.

### EXAMPLE 2

The ingredients set forth below in Table 2 for an electrolyte gel formulation are provided.

TABLE 2

| | | Weight |
|---|---|---|
| | | (gm) in |
| Ingredient | Weight % | 100 grams |
| Purified Water | 40.3077 | 40.3077 |
| Monk Fruit | 6.9200 | 6.9200 |
| (Sweetener) | | |
| Reb. A./citrus extract | 1.7500 | 1.7500 |
| (Sweetener) | | |
| 1,2,3-propanetriol | 2.0000 | 2.0000 |
| Citric Acid | 22.0000 | 22.0000 |
| Xanthan Gum | 0.6500 | 0.6500 |
| Potassium Sorbate | 0.0500 | 0.0500 |
| Monopotassium | 11.7340 | 11.7340 |
| Phosphate | | |
| Magnesium Lactate | 0.1470 | 90.1470 |
| Calcium Lactate | 0.1470 | 0.1470 |
| Gluconate | | |
| Natural Lemon Lime | 11.0000 | 11.0000 |
| Favor #50.923 | | |
| Vitamin B12 | 0.0900 | 0.0900 |
| Vitamin B3 | 0.2933 | 0.2933 |
| Vitamin B6 | 0.0293 | 0.0293 |
| Vitamin B5 | 0.0293 | 0.0293 |
| Carotene Coloring | 2.9330 | 2.9330 |
| TOTALS | 100.00 | 100.00 |
| Totals without water | 59.69 | 51.02 |

### Mixing Instructions

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. In a separate container, suspend xanthan gum in glycerine to produce a xanthan gum suspension.
7. Add xanthan gum suspension to homogeneous composition and mix until uniform to produce the final composition.

The final gel composition has a pH of 2.2 and a viscosity of 9080 centipoise.

### EXAMPLE 3

The ingredients set forth below in Table 3 for an antioxidant gel formulation are provided.

TABLE 3

| | | Weight |
|---|---|---|
| | | (gm) in |
| Ingredient | Weight % | 100 grams |
| Purified Water | 36.1063 | 36.1063 |
| Monk Fruit | 7.900 | 7.900 |
| (Sweetener) | | |
| Reb. A./citrus extract | 2.000 | 2.000 |
| (Sweetener) | | |
| Vitamin C | 2.630 | 2.630 |
| Malic Acid | 1.7850 | 1.7850 |
| Citric Acid | 6.8250 | 6.8250 |
| 1,2,3 propanetriol | 2.000 | 2.000 |
| Xanthan Gum | 0.6500 | 0.6500 |
| Tocopheryl Acetate | 5.2500 | 5.2500 |
| Potassium sorbate | 0.0800 | 0.0800 |
| Natural Favor, JC68 | 31.0000 | 31.0000 |
| #27878 (Flavoring) | | |
| Vitamin B12 | 0.0105 | 0.0105 |
| Vitamin B3 | 0.3360 | 0.3360 |
| Vitamin B6 | 0.0336 | 0.0336 |
| Vitamin B5 | 0.0336 | 0.0336 |
| Color Product | | |
| #181524 (Coloring) | | |
| TOTALS | 100.00 | 100.00 |
| Totals without water | 63.89 | 51.36 |

### Mixing Instructions

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. In a separate container, suspend xanthan gum in glycerine to produce a xanthan gum suspension.
7. Add xanthan gum suspension to homogeneous composition and mix until uniform to produce the final composition.

The final gel composition has a pH of 2.0, and a viscosity of 4040 centipoise.

### EXAMPLE 4

The ingredients set forth below in Table 4 for an aqueous energy formulation are provided.

TABLE 4

| | | Weight |
|---|---|---|
| | | (gm) in |
| Ingredient | Weight % | 100 grams |
| Purified Water | 40.6050 | 40.6050 |
| Sucralose | 2.1030 | 2.1030 |
| (Sweetener) | | |
| Acesulfame | 1.0450 | 1.0450 |
| Potassium | | |
| (Sweetener) | | |
| Vitamin C | 3.5500 | 3.5500 |
| Citric Acid | 7.3100 | 7.3100 |
| 1,3-propanediol | 2.0000 | 2.0000 |
| Piperines | 0.4280 | 0.4280 |
| Taurine | 3.4500 | 3.4500 |
| Potassium sorbate | 0.0500 | 0.0500 |
| Natural Flavoring | 29.7540 | 29.7540 |
| Vitamin B12 | 0.0104 | 0.0104 |
| Vitamin B3 | 0.3450 | 0.3450 |
| L-theanine | 0.4600 | 0.4600 |
| Inositol | 0.4600 | 0.4600 |
| Caffeine powder | 4.2810 | 4.2810 |
| Caffeine powder | 2.0880 | 2.0880 |
| Vitamin B5 | 0.0345 | 0.0345 |
| TOTALS | 100.00 | 100.00 |
| Totals without water | 59.69 | 51.02 |

### Mixing Instructions:

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. Add 1,3 propanediol to homogeneous composition and mix until uniform to produce the final composition.

The final composition has a pH of 2.4 and a viscosity of 104 centipoise.

### EXAMPLE 5

The ingredients set forth below in Table 5 for an aqueous electrolyte formulation are provided.

TABLE 5

| | | Weight |
|---|---|---|
| | | (gm) in |
| Ingredient | Weight % | 100 grams |
| Purified Water | 40.9577 | 40.9577 |
| Monk Fruit | 6.9200 | 6.9200 |
| (Sweetener) | | |
| Reb. A./citrus extract | 1.7500 | 1.7500 |
| (Sweetener) | | |
| 1,2,3-propanetriol | 2.0000 | 2.0000 |
| Citric Acid | 22.0000 | 22.0000 |
| Potassium Sorbate | 0.0500 | 0.0500 |
| Monopotassium | 11.7340 | 11.7340 |
| Phosphate | | |
| Magnesium Lactate | 0.1470 | 90.1470 |
| Calcium Lactate | 0.1470 | 0.1470 |
| Gluconate | | |
| Natural Lemon Lime | 11.0000 | 11.0000 |
| Favor #50.923 | | |
| Vitamin B12 | 0.0900 | 0.0900 |
| Vitamin B3 | 0.2933 | 0.2933 |
| Vitamin B6 | 0.0293 | 0.0293 |
| Vitamin B5 | 0.0293 | 0.0293 |
| Carotene Coloring | 2.9330 | 2.9330 |
| TOTALS | 100.00 | 100.00 |
| Totals without water | 59.69 | 51.02 |

### Mixing Instructions

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. Add glycerine to homogeneous composition and mix until uniform to produce a final composition.

The final composition has a pH of 2.2 and a viscosity of 212 centipoise.

### EXAMPLE 6

The ingredients set forth below in Table 6 for an aqueous antioxidant formulation are provided.

TABLE 6

| | | Weight |
|---|---|---|
| | | (gm) in |
| Ingredient | Weight % | 100 grams |
| Purified Water | 36.7563 | 36.7563 |
| Monk Fruit | 7.900 | 7.900 |
| (Sweetener) | | |
| Reb. A./citrus extract | 2.000 | 2.000 |
| (Sweetener) | | |
| Vitamin C | 2.630 | 2.630 |
| Malic Acid | 1.7850 | 1.7850 |
| Citric Acid | 6.8250 | 6.8250 |
| 1,2,3 propanetriol | 2.000 | 2.000 |
| Tocopheryl Acetate | 5.2500 | 5.2500 |
| Potassium sorbate | 0.0800 | 0.0800 |
| Natural Favor, JC68 | 31.0000 | 31.0000 |
| #27878 (Flavoring) | | |
| Vitamin B12 | 0.0105 | 0.0105 |
| Vitamin B3 | 0.3360 | 0.3360 |
| Vitamin B6 | 0.0336 | 0.0336 |
| Vitamin B5 | 0.0336 | 0.0336 |
| Color Product | | |
| #181524 | | |
| TOTALS | 100.00 | 100.00 |
| Totals without water | 63.89 | 51.36 |

### Mixing Instructions

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. Add glycerine to homogeneous composition and mix until uniform to produce the final composition.

The final composition has a pH of 2.0 and a viscosity of 118 centipoise.

### EXAMPLE 7

The gel concentrate of Example 1 is placed in a bottle which dispenses measured doses of the gel. Each dose comprises one cc of the gel. In use, one dose of the gel is admixed with each eight ounces of water or another beverage, and the desired quantity of beverage is then ingested.

### EXAMPLE 8

Example 7 is repeated, except that the gel concentrate of Example 2 is utilized instead of the concentrate of Example 1. Similar results are obtained, i.e., one cc of the concentrate is admixed to eight ounces of water or another beverage and the desired quantity of the beverage is then ingested.

### EXAMPLE 9

Example 7 is repeated, except that the gel concentrate of Example 3 is utilized instead of the concentrate of Example 1. Similar results are obtained.

### EXAMPLE 10

Example 7 is repeated, except that the composition of Example 4 is utilized instead of the concentrate of Example 1. Similar results are obtained.

### EXAMPLE 11

Example 7 is repeated, except that the composition of Example 5 is utilized instead of the concentrate of Example 1. Similar results are obtained.

### EXAMPLE 12

Example 7 is repeated, except that the composition of Example 6 is utilized instead.

### EXAMPLE 13

Two hundred bottles of water (16.9 ounces of water in each bottle) are provided. Two doses (2 cc total) of the gel concentrate of Example 1 are admixed with the water in each 16.9 bottle. These bottles are called the formulation bottles.

An additional two hundred bottles of water (16.9 ounces of water in each bottle) are provided. These bottles are called the control bottles.

A first soccer team of eighteen male players is provided. The average weight of players on the first team is 77.6 kg. A second soccer team of eighteen male player is provided. The average weight of players on the second team is 79.2 kg.

One hour prior to playing a game with the second team on an outdoor soccer field on a clear day at an ambient temperature of 76 degrees F. and a relative humidity of 30%, the first soccer team is provided access to the formulation bottles at an outdoor location adjacent the soccer field, and is given fifteen minutes to hydrate in preparation for the game. During the fifteen minute period, each player drinks an average of 44 ounces of water from the formulation bottles. At the end of the fifteen minute period, the first team warms up in preparation for the game.

One hour prior to playing the game with the first team, the second soccer team is provided access to the control bottle at an outdoor location adjacent the soccer field and is given fifteen minutes to hydrate in preparation for the game. During the fifteen minute period, each player drinks an average of 26 ounces of water from the control bottles. At the end of the fifteen minute period, the second team warms up in preparation for the game.

During the game, eleven players from the first team play the entire game, and eleven players from the second team play the entire game. The eleven players from the first team have an average weight of 78.2 kg. The eleven players from the second team have an average weight of 79.6 kg. During the game, and for fifteen minutes after the conclusion of the game, the eleven players from the first team are provided access to the formulation bottles to drink as much as they desire. The eleven players from the first team each drink an average of 86 ounces of water from the formulation bottles during the period extending from the start of the game through fifteen minutes after the game.

During the game, and for fifteen minutes after the conclusion of the game, the eleven players from the second team are provided access to the control bottles to drink as much as they desire. The eleven players from the second team each drink an average of 76 ounces of water from the control bottles during the period extending from the start of the game through fifteen minutes after the game.

The only fluids provided players on each team prior to, during, and after the game are the fluids described above, i.e., the formulation bottles and the control bottles.

### EXAMPLE 14

Example 13 is repeated except the control bottles comprise GATORADE™.
The results are similar except that during the fifteen minute hydration prior to the game, the each member of the second team drank an average of 32 ounces of GATORADE™, and during the period extending from the beginning of the game until the end of fifteen minutes after the game, each member of the second team drank an average of 80 ounces of GATORADE™.

### EXAMPLE 15

Examples 13 and 14 are repeated, except that the gel concentrate of Example 2 is substituted for the gel concentrate of Example 1. Similar results are obtained.

### EXAMPLE 16

Examples 13 and 14 are repeated, except that the gel concentrate of Example 3 is substituted for the gel concentrate of Example 1. Similar results are obtained.

### EXAMPLE 17

Examples 13 and 14 are repeated, except that the final composition of Example 4 is substituted for the gel concentrate of Example 1. Similar results are obtained.

### EXAMPLE 18

Examples 13 and 14 are repeated, except that the final composition of Example 5 is substituted for the gel concentrate of Example 1. Similar results are obtained.

### EXAMPLE 19

Examples 13 and 14 are repeated, except that the final composition of Example 6 is substituted for the gel concentrate of Example 1. Similar results are obtained.

### EXAMPLE 20

The ingredients set forth below in Table 7 for a caffeinated natural aqueous energy formulation are provided.

TABLE 7

| | | Weight |
|---|---|---|
| | | (gm) in |
| Ingredient | Weight % | 100 grams |
| Purified Water | 34.8550 | 34.8550 |
| Sucralose | 2.1030 | 2.1030 |
| (Sweetener) | | |
| Acesulfame | 1.0450 | 1.0450 |
| Potassium | | |
| (Sweetener) | | |
| Vitamin C | 3.5500 | 3.5500 |
| Citric Acid | 7.3100 | 7.3100 |
| 1,3-propanediol | 2.0000 | 2.0000 |
| Piperines | 0.4280 | 0.4280 |
| Taurine | 3.4500 | 3.4500 |
| Potassium sorbate | 0.0500 | 0.0500 |
| Natural Flavoring | 29.7540 | 29.7540 |
| Vitamin B12 | 0.0104 | 0.0104 |
| Vitamin B3 | 0.3450 | 0.3450 |
| L-theanine | 0.4600 | 0.4600 |
| Inositol | 0.4600 | 0.4600 |
| Caffeine powder | 4.2810 | 4.2810 |
| Caffeine powder | 2.0880 | 2.0880 |
| Vitamin B5 | 0.0345 | 0.0345 |
| ATP | 3.5000 | 3.5000 |
| Cordyceps-synesis | 0.2500 | 0.2500 |
| CoQ10 | 2.000 | 2.000 |
| TOTALS | 100.00 | 100.00 |
| Totals without water | 59.69 | 51.02 |

### Mixing Instructions:

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins, ATP, CoQ10, and cordyceps to 3^{rd} aqueous solution and mix until dissolved to produce 4^{th} aqueous solution.
5. Add coloring and flavors to 4^{th} aqueous solution and mix until homogenous composition produced.
6. Add 1,3 propanediol to homogeneous composition and mix until uniform to produce the final composition.

The final composition has a pH of 2.4 and a viscosity of 104 centipoise.

### EXAMPLE 21

The ingredients set forth below in Table 8 for a non-caffeinated natural aqueous energy formulation are provided.

TABLE 8

| | | Weight |
|---|---|---|
| | | (gm) in |
| Ingredient | Weight % | 100 grams |
| Purified Water | 41.6840 | 41.6840 |
| Sucralose | 2.1030 | 2.1030 |
| (Sweetener) | | |
| Acesulfame | 1.0450 | 1.0450 |
| Potassium | | |
| (Sweetener) | | |
| Vitamin C | 3.5500 | 3.5500 |
| Citric Acid | 7.3100 | 7.3100 |
| 1,3-propanediol | 2.0000 | 2.0000 |
| Piperines | 0.4280 | 0.4280 |
| Taurine | 3.4500 | 3.4500 |
| Potassium sorbate | 0.0500 | 0.0500 |
| Natural Flavoring | 29.7540 | 29.7540 |
| Vitamin B12 | 0.0104 | 0.0104 |
| Vitamin B3 | 0.3450 | 0.3450 |
| Inositol | 0.4600 | 0.4600 |
| Vitamin B5 | 0.0345 | 0.0345 |
| ATP | 3.5000 | 3.5000 |
| Cordyceps-synesis | 0.2500 | 0.2500 |
| CoQ10 | 2.000 | 2.000 |
| TOTALS | 100.00 | 100.00 |
| Totals without water | 59.69 | 51.02 |

### Mixing Instructions:

The following mixing steps are conducted at room temperature.
1. Add potassium sorbate to water and mix until dissolved to produce 1^{st} aqueous solution.
2. Add acids to 1^{st} aqueous solution and mix until dissolved to produce 2^{nd} aqueous solution.
3. Add minerals to 2^{nd} aqueous solution and mix until dissolved to produce 3^{rd} aqueous solution.
4. Add vitamins to 3^{rd} aqueous solution and mix until dissolved to produce 4^{th} aqueous solution.
5. Add coloring and flavors to 4^{th} aqueous solution and mix until homogenous composition produced.
6. Add 1,3 propanediol to homogeneous composition and mix until uniform to produce the final composition.

The final composition has a pH of 2.4 and a viscosity of 104 centipoise.

### EXAMPLE 22

Example 2 is repeated, except 0.1% by weight of piperines is added to the formulation. The amount of water is decreased by 0.1% by weight to compensate for the addition of the piperines. Similar results are obtained.

### EXAMPLE 23

Example 3 is repeated, except 0.05% by weight of piperines is added to the formulation. The amount of water is decreased by 0.05% by weight to compensate for the addition of the piperines. Similar results are obtained.

### EXAMPLE 24

Example 5 is repeated, except 0.25% by weight of piperines is added to the formulation. The amount of water is decreased by 0.25% to compensate for the addition of the piperines. Similar results are obtained.

### EXAMPLE 25

Example 6 is repeated, except 0.15% by weight of piperines is added to the formulation. The amount of water is decreased by 0.15% by weight to compensate for the addition of the piperines. Similar results are obtained.

Piperines in each of Tables 2, 3, 5, 6 0.1 or 0.05 piperines go on lower end.

### EXAMPLE 26

Examples 13 and 14 are repeated, except that the final composition of Example 22 is substituted for the gel concentrate of Example 1. Similar results are obtained.

### EXAMPLE 27

Examples 13 and 14 are repeated, except that the final composition of Example 23 is substituted for the gel concentrate of Example 1. Similar results are obtained.

### EXAMPLE 28

Examples 13 and 14 are repeated, except that the final composition of Example 24 is substituted for the gel concentrate of Example 1. Similar results are obtained.

### EXAMPLE 29

Examples 13 and 14 are repeated, except that the final composition of Example 25 is substituted for the gel concentrate of Example 1. Similar results are obtained.

An individual's sweat rate is readily calculated. Table 9 on the following page sets forth typical sweat rates and fluid intakes utilized to offset fluid and electrolyte loss. The sweat rate is calculated by taking a person's weight before an athletic event (or other event or pastime), by determining how long the event lasted, by weighing the person after the athletic event, by subtracting the weight after the event from the weight before the event to get a differential, and by then dividing the differential by the length of the event in hours. If, for example, the individual weighs 100 pounds before the event, and 96 pounds after, and the event is two hours long, then the sweat rate is two pounds per hour. However, if the individual ingests one pound of water during the event, then the sweat rate is four pounds+one pound divided by two, or two and one half pounds per hour. Once the sweat rate is known, the amount of water the individual should take during the event, if it is permissible for the individual to ingest water during the event, can be calculated or estimated. For example, if the event is basketball, during time outs or half-time or between quarters, it likely would be permissible for the individual to ingest fluid. If the loss of fluid per hour is known, the loss of electrolytes can also be estimated so that the quantity of electrolytes which should be in fluids ingested by the individual can be calculated or, at least, estimated. A one cc dose of the aqueous formulations of Example 2 and 5 contains about fifty mg of potassium, 0.2 mg of magnesium, and 0.25 mg of calcium. Consequently, one or two doses (each dose comprising one cc) of each formulation would provide most or all of the recommended potassium replenishments set forth below in Table 9 for the various sports.

TABLE 9

| | | Sweat | Sweat | | Fluid | | | |
|---|---|---|---|---|---|---|---|---|
| | | Rate | Rate | Fluid | Intake | Recommended | Recommended | Recommended |
| | | (L/hr) | (L/hr) | Intake (L) | (L) | Replenishment | Replenishment | Replenishment |
| Sport | Condition | Mean | Range | Mean | Range | Fluids (oz) | Sodium (mg) | Potassium (mg) |
| Basketball | Summer | 1.49 | 1.37 to | 0.80 | 0.35 to | 20 | 275 | 75 |
| | Training | | 1.60 | | 1.25 | | | |
| Soccer | Summer | 1.11 | 0.99 to | 1.11 | 0.99 to | 16 | 220 | 60 |
| | Training | | 1.21 | | 1.21 | | | |
| Tennis | Summer | 1.60 | 0.62 to | 0.62 to | 0.25 to | 22 | 300 | 80 |
| | Competition | | 2.58 | 2.58 | 2.25 | | | |
| Long | Summer | 1.77 | 0.99 to | 0.57 | 0.00 to | 24 | 330 | 90 |
| Distance | Training | | 2.55 | | 1.30 | | | |
| Running | | | | | | | | |

A particular benefit of the aqueous concentrates of the invention is that they are readily transported in a relatively small container and have known quantities of electrolytes, vitamins, minerals, and other nutritional components. Consequently, the number of one cc “doses” necessary to provide the electrolytes and other nutritional components that are lost by an individual as defined by the individual's sweat rate can be readily determined and, at a minimum approximated, so that a customized hydration program can be designed for the individual. Further, the thirst inducing aqueous concentrates of the invention assist an individual in ingesting the quantities of water necessary to improve the individual's hydration before, during, and after an athletic event or other activity. Providing a customized hydration program and utilizing the thirst inducing aqueous formulations of the invention provide an efficient, novel methodology for minimizing or preventing dehydration. Consequently, if an individual's sweat rate for basketball is determined to be about 1.5 L per hour, then after one hour of exercise, one and one half doses (where one cc equals one dose and one and one half cc equals one and one-half doses) of the formulation of Example 2 or Example 5 is admixed to twelve ounces of water and the resulting water-formulation mixture is ingested by the individual. Or, the resulting twelve ounces of the water-formulation mixture is ingested during the first hour the individual plays basketball. Or, the resulting twelve ounces of the water-formulation mixture is ingested before the individual plays basketball so that the individual's body is provided with additional potassium before exercising.

Having described our invention in such terms as to enable those skilled in the art to understand and practice it, and having described the presently preferred embodiments thereof,

We claim:

1. A system to hydrate an individual prior to participation in a sporting event, comprising a container charged with a thirst inducing aqueous nutritional supplement gel composition and configured to dispense repeatedly a dose of said aqueous gel composition having a selected volume, said selected volume being in the range of 0.25 to 3.0 cc, said thirst inducing gel composition
(a) having a viscosity in the range of 3000 to 12,500
(b) having a pH in the range of 2.0 to 2.8;
(c) including
(i) 9% to 30% by weight of a flavoring,
(ii) at least one acidulant selected from a group consisting of citric acid, ascorbic acid, malic acid, and tartaric acid,
(iii) at least one sweetener,
(iv) 0.03 to 0.09% by weight of piperines, and
(v) 35% to 40% by weight water.

2. A system to hydrate an individual prior to participation in a sporting event, comprising a container charged with a thirst inducing aqueous nutritional supplement gel composition and configured to dispense repeatedly a dose of said aqueous gel composition having a selected volume, said selected volume being in the range of 0.25 to 3.0 cc, said thirst inducing gel composition
(a) having a viscosity in the range of 3000 to 12,500
(b) having a pH in the range of 2.0 to 2.8;
(c) including
(i) 9% to 30% by weight of a flavoring,
(ii) at least one acidulant selected from a group consisting of citric acid, ascorbic acid, malic acid, and tartaric acid,
(iii) at least one sweetener,
(iv) 0.03 to 0.09% by weight of piperines,
(v) 8.0% to 15% by weight monopotassium phosphate, and
(v) 35% to 40% by weight water.

3. A system to increase available cellular energy and to hydrate an individual prior to participation in a sporting event, comprising a container charged with a thirst inducing aqueous nutritional supplement gel composition and configured to dispense repeatedly a dose of said aqueous gel composition having a selected volume, said selected volume being in the range of 0.25 to 3.0 cc, said thirst inducing gel composition
(a) having a viscosity in the range of 3000 to 12,500
(b) having a pH in the range of 2.0 to 2.8;
(c) including
(i) 9% to 30% by weight of a flavoring,
(ii) at least one acidulant selected from a group consisting of citric acid, ascorbic acid, malic acid, and tartaric acid,
(iii) at least one sweetener,
(iv) 0.03 to 0.09% by weight of piperines,
(v) 2% to 6% by weight ATP,
(vi) 0.05% to 1.2% by weight cordyceps-sinensis,
(vii) 1.5% to 4.0% by weight CoQ10, and
(viii) 35% to 40% by weight water.
